(19) United States
(12) Patent Application Publication
(10) Pub. No.: US 2006/0100977 A1
(43) Pub. Date: May 11, 2006

(54) System and method for using embedded supplemental information

(76) Inventors: Ya-Ling Hsu, Taipei City (TW); Wen-Hsiang Lee, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/973,685

(22) Filed: Oct. 26, 2004

(51) Int. Cl. G06F 17/30

(52) U.S. Cl. 707/1

(57) ABSTRACT

An apparatus for managing a library of enhanced works of content, which are defined as a compilation of a work of content and a supplemental information record that carries information related to the work of content, includes a memory and a processor. The memory includes enhanced work management module. The processor is in communication with the memory. The processor is adapted to implement the enhanced work management module to access a given supplemental information record of an enhanced work of content that is included in a library of enhanced works of content and adapted to receive a user input and to process the user input with at least a portion of the given supplemental information record.

### RELATED APPLICATION

This application is related to co-pending U.S utility patent application entitled “SYSTEM AND METHOD FOR EMBEDDING SUPPLEMENTAL INFORMATION INTO A DIGITAL STREAM OF A WORK OF CONTENT” filed on the same date and accorded Ser. No. ______ (Attorney Docket No. 250318-1120), which is entirely incorporated herein by reference.

### TECHNICAL FIELD

The present invention is generally related to system and methods of managing digital content and, more particularly, is related to a system and method for using an embedded supplemental information record, which includes information related to a given work.

### BACKGROUND

A user of a service provider such as a television system, which include wire, cable, and wireless television systems, receives works of content, e.g., programs, movies, etc. Frequently, the user will record the works of content so that the user can view the works of content at times of his or her own choosing. The user might use a computer system or a digital recorder to record on a storage device the works of content in a digital format. Typically, the storage devices that are employed with computer systems and/or digital recorders of today are large enough to hold many digitized works of content, and the trend for the future is that storage devices will become less expensive with larger storage capacity. Thus, a user of a service provider can create their own library of digitized works of content, and the library can become very large.

Frequently, as a user's library becomes larger and larger, the user will have a harder time managing the library. As the library becomes larger, the user will have a harder time remembering, among other things, which works of content are which; what is the plot of a given work of content; whether a given work of content was good and worth keeping or bad and should be deleted. These are only some of the problems related to managing a large library of works of content. Other problems include, but are not limited to, finding and/or selecting a particular work of content and restricting access to particular works of content.

Thus, there exists a need for an apparatus and a method for providing the user with the ability manage his or her library of digitized works of content.

### SUMMARY OF THE INVENTION

Embodiments of the present invention provide an apparatus and method for managing a library of enhanced works of content. An enhanced works of content is defined as a compilation of a work of content and a supplemental information record that carries information related to the work of content. Briefly described, in architecture, one embodiment of the apparatus, among others, includes a processor and a memory. The memory has an enhanced work management module stored therein. The processor is in communication with the memory. The processor is adapted to implement the enhanced work management module to access a given supplemental information record of an enhanced work of content that is included in a library of enhanced works of content. Implementing the enhanced work management module, the processor is also adapted to receive a user input and to process the user input with at least a portion of the given supplemental information record.

Embodiments of the present invention can also be viewed as providing methods for managing a library of enhanced works of content. In this regard, one embodiment of such a method, among others, includes the step of accessing the library of enhanced works of content. An enhanced work of content is defined as a work of content and a supplemental information record that carries information related to the work of content. The method also includes the steps of receiving a user input; and processing the user input with at least a portion of the supplemental information.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of one embodiment of a system, which includes a head end of a service provider, for providing works of content to a computer system and to a digital recorder.

FIG. 2 is a block diagram of the computer system of FIG. 1.

FIG. 3 is a block diagram of memory.

FIG. 4 is a block diagram of a storage device.

FIG. 5 is a block diagram of a supplemental information record.

FIGS. 6A-6F are block diagrams of menus provided to a user.

FIGS. 7-9 are flow charts depicting using an embedded supplemental information record.

### DETAILED DESCRIPTION OF THE PREFERRED EMBODIMENT

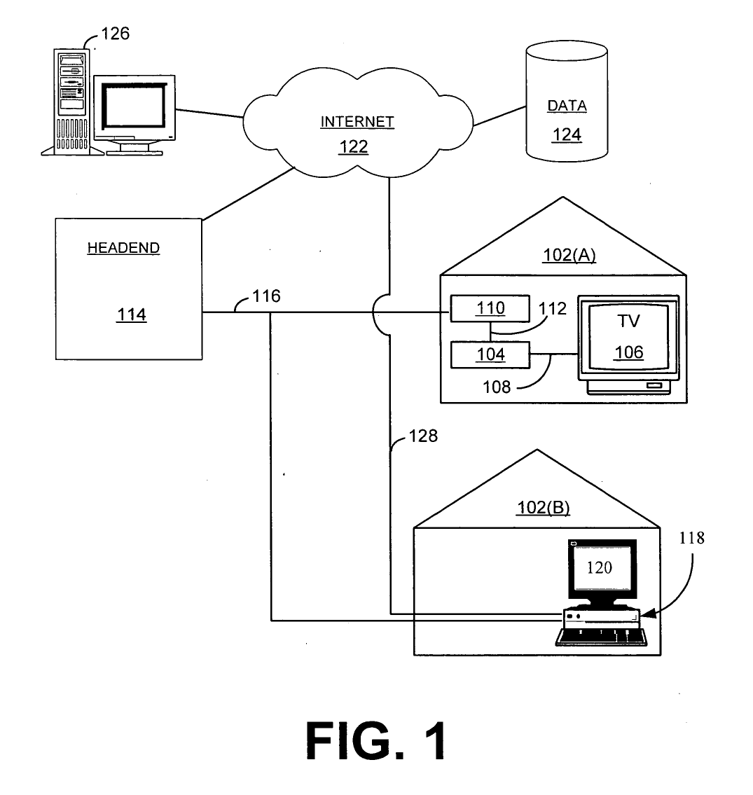

Referring to FIG. 1, located in a first user premise 102(A) is a digital recorder 104. The digital recorder 104 is in communication with a display device 106, which is typically a television set, via a communication link 108. The digital recorder 104 is adapted to receive works of content, determine supplemental information related to the received works, and generate a supplemental information record having the supplemental information included therein. The digital recorder 104 is also adapted to record enhanced works of digital content. For the purposes of this disclosure an “enhanced work” is defined as a compilation of a work of content and a supplemental information record, wherein the supplemental information record includes information related to the work. Typically, the supplemental information record is embedded into the work of content during the recording of the work of content. Furthermore, the digital recorder 104 is adapted to manage the recorded enhanced works using the supplemental information record embedded within the enhanced work.

In one embodiment, the digital recorder 104 is also in communication with a settop box 110 via communication link 112. The settop box 110 receives works of content from a head end 114 of a service provider via a communication link 116. Typically, the works of content from the service provider include encrypted works, and the settop box 110 is adapted to decrypt the encrypted works before providing them to the digital recorder 104. In some embodiments, the digital recorder 104 is adapted to receive encrypted works of content and decrypt them so that the settop box 110 is unnecessary.

In addition to providing works of content, the head end 114 typically provides system information such as electronic program guide tables (EPGT), which are used by electronic program guide applications (or modules) to provide programming and scheduling information to users of the service provider. Typically, EPGTs include programming/scheduling information for, among other things, works of content that are to be transmitted in the future, e.g., tomorrow, next week, etc.

Typically, the head end 114 provides works of content in both digital and analog format. In analog format, the EPGTs are carried in the vertical blanking interval (VBI) of the analog signal. In digital format, the EPGTs are carried in digitized packets. For example, in one embodiment, the head end 114 provides users of the service provider with a transport stream via the communication link 116. The transport stream typically carries several works of content, which are carried in packets, such that the packets of different works of content are multiplexed together. In one embodiment, the transport stream employs an MPEG-type architecture where all the packets have a packet identifier (PID). The service provider normally reserves certain PID values for system information such as program association tables (PAT) and/or EPGTs. In an MPEG-type architecture, a PAT associates a PID value, which can be dynamically assignable, i.e., non-reserved, with a program map table (PMT) for a specific work of content (program) that is being carried in the transport stream. The PMT associates PID values with elementary streams that make-up the specific work of content.

A computer system 118, which is located in the subscriber premises 102(B) is also in communication with the head end 114 of the service provider via the communication link 116 and with the internet 122 via communication link 128. The computer system 118 includes a display device 120 on which content can be displayed to a user. The computer system 118 is adapted to receive works of content, determine supplemental information related to the received works, and generate a supplemental information record having the supplemental information included therein. The computer system 118 is also adapted to record enhanced works of digital content. Similar to the digital recorder 104, the computer system 118 is also adapted to manage the recorded enhanced works using the supplemental information record embedded within the enhanced work.

In some embodiments, the service provider is a cable television or a subscription television service provider, and the communication link 116 is a wired, optical, or wireless communication link. Typically, the head end 114 provides works of content in both analog and digital format, and frequently, the service provider also provides Internet services to its users. In that case, the digital recorder 104 is in communication with a database 124 and with a server 126 via the Internet 122.

The database 124 includes supplemental information related to given works of content. Non-limiting examples of supplemental information for a given work of content include: title; episode name/title; year of copyright; content rating, e.g., General (G), Parental Guidance (PG), PG-13, Restricted (R), NC-17; performers (actors, actresses, musicians, etc.); genre (adventure, romance, action, animation, documentary, western, science fiction, etc.); awards (Oscar, Tony, People's Choice, Golden Palm, etc.) and category of award (best actor, best actress, best motion picture, best special effects, etc.); and critical reviews, e.g., published reviews by movie critics. In some embodiments, the database 124 is adapted to respond to query messages from the digital recorder 104 and/or the computer system 118 by providing supplemental information requested by the query message. In another embodiment, the database 124 is searchable such that the digital recorder 104 and/or the computer system 118 can search for and retrieve supplemental information. Furthermore, in some embodiments, the database 124 also includes works of content that can be provided to the digital recorder 104 and the computer system 118.

In some embodiments, the server 126 can provide works of content and/or supplemental information related to a given work of content to the digital recorder 104 and/or the computer system 118. The server 126 is adapted to receive a query message from the digital recorder 104 and/or the computer system 118 and search the database 124 for supplemental information related to a given work of content. The server 126 is also adapted to provide the sender of the query message with a response, which includes the search results, e.g., supplemental information record, from the database 124. The server 126 can also provide works of content, which are stored in the database 124, to the digital recorder 104 and the computer system 118.

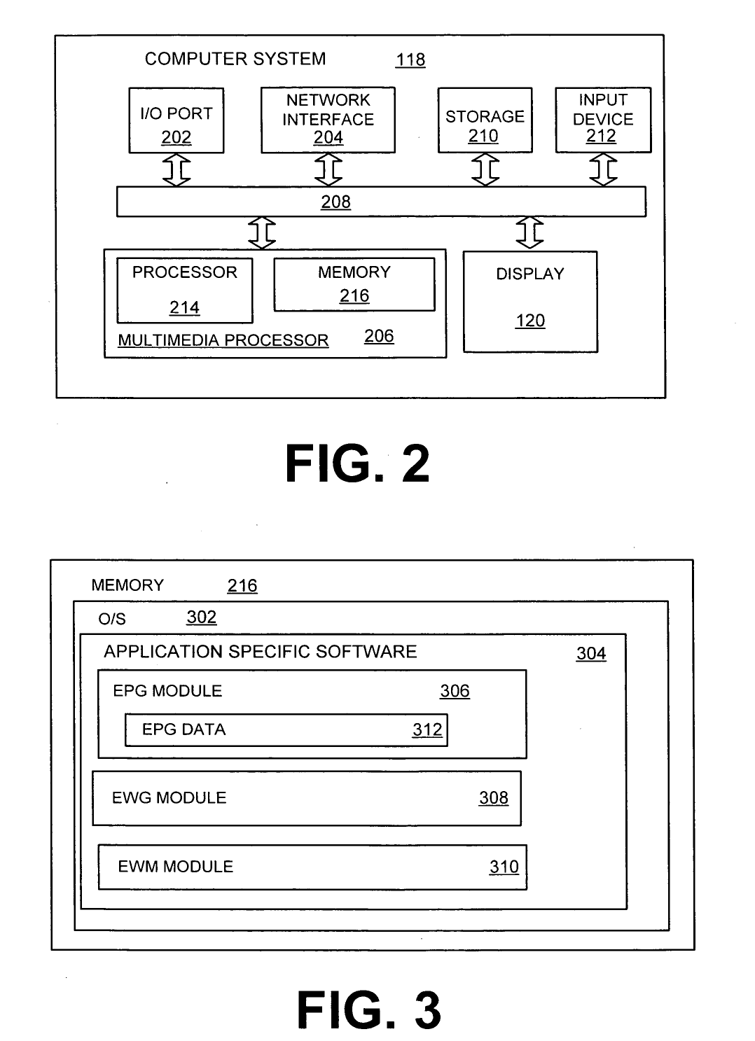

FIG. 2 illustrates selected components of the computer system 118. Generally, the digital recorder 104 includes the components, except for the display 120, illustrated in FIG. 2. Thus, the digital recorder 104 is not discussed in detail. The computer system 118 includes an input/output port 202, which is adapted to couple with communication link 116, and a network interface 204, which is adapted to couple to the communication link 128. Works of multimedia content can be received through the I/O port 202 and through the network interface 204. The received works of multimedia content are provided to a multimedia processor 206 via a bus 208. The I/O port 202 may include a plurality of interfaces such that it can receive (and provide) content from (and to) a plurality of devices in a plurality of formats.

A network interface comprises various components used to transmit and/or receive data over networks. By way of example, the network interface device 204 may include a device that can communicate with both inputs and outputs, for instance, a modulator/demodulator (e.g., a modem), wireless (e.g., radio frequency (RF)) transceiver, a telephonic interface, a bridge, a router, network card, etc.).

A mass storage device 210 is in communication with the multimedia processor 206 via the bus 208. The mass storage device 210 is adapted to store enhanced works of content so that the works included therein can be replayed at a later time. A user can use an input device 212 for providing user input. For the computer system 118, the input device 212 is generally a keyboard and mouse. However, for the digital recorder 104 the input device 212 can be, but is not limited to, a keypad, a remote control, or other devices known to those skilled in the art such as a stylus.

The multimedia processor 206 includes a processor 214 and a memory 216. Among other things, the processor 214 implements user commands and modules stored in the memory 216. The memory 216 can include any one of a combination of volatile memory elements (e.g., random-access memory (RAM, such as DRAM, and SRAM, etc.)) and nonvolatile memory elements (e.g., ROM, hard drive, tape, CDROM, etc.).

The multimedia processor 206 is adapted to receive content and then reformat, if necessary, the content to a desired format such as, but not limited to, motion pictures expert group (MPEG), Advanced Visual Interface (AVI), Windows Media Video (WMV), Digital Versatile Disc (DVD), Versatile Compact Disc (VCD), and others known to those skilled in the art. Among other reasons, the multimedia processor 206 reformats works of multimedia content so that the works are in appropriate format for display and so that the works are physically compressed on the mass storage device 210.

The multimedia processor 206 is also adapted to generate a supplemental information record for a given work, and embed the supplemental information record into a bit stream that comprises the given work, thereby generating an enhanced work of content. Enhanced works of content are stored on the storage device 210. Over time a library of enhanced works is created on the storage device 210 as the user stores more and more enhanced works. The multimedia processor 206 is adapted to manage the library and provide a user friendly interface for accessing enhanced works using embedded supplemental information records.

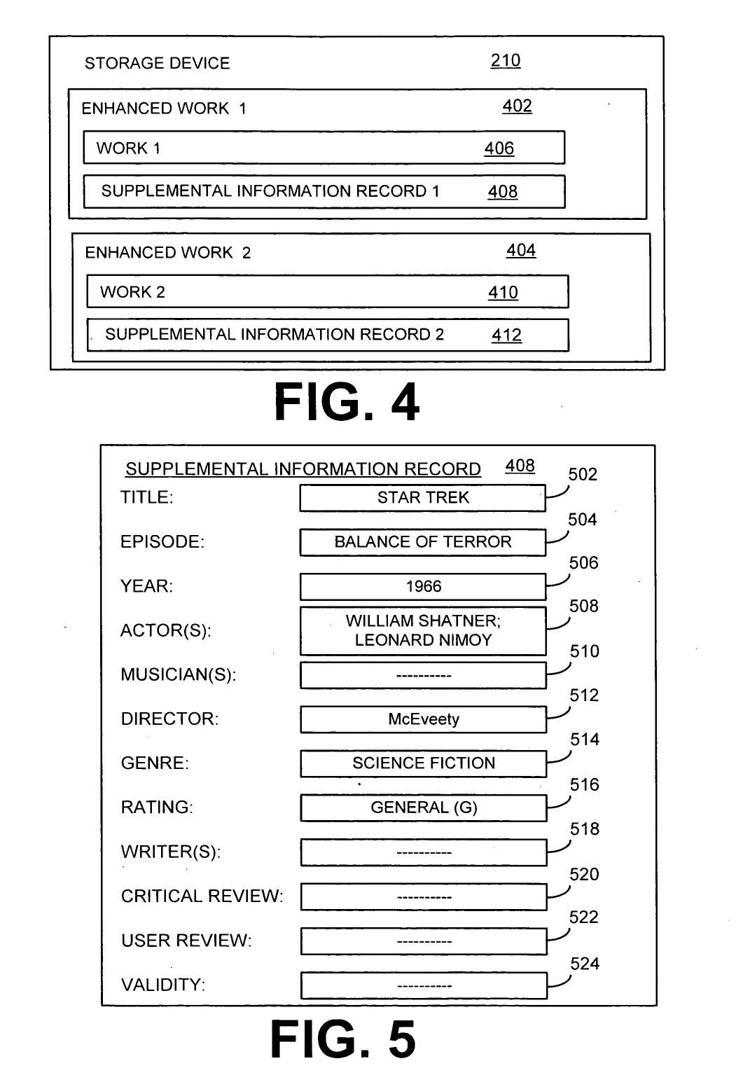

FIG. 3 further illustrates the memory 216. The memory 216 includes an operating system 302 and an application specific module 304, which includes an EPG module 306, an Enhanced Work Generator (EWG) module 308, and an Enhanced Work Manager (EWM) module 310. The processor 214 implements the O/S 302 to, among other things, provide menu options to the user and interpret user input. In some embodiments, the memory 216 may include one or more native applications, emulation systems, or emulated applications for any of a variety of operating systems and/or emulated hardware platforms, emulated operating systems, etc. One of ordinary skill in the art will appreciate that memory 216 can, and typically will, comprise other components, which have been omitted for purposes of brevity.

The application specific software program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

The EPG module 306 includes logic for providing electronic program guide functionality, such as but not limited to, displaying programming information and providing recording instructions to the EWG 308. The EPG module 306 includes the EPG data 312, which is usually provided to the EPG module 306 via tables transmitted from the head end 114. Typically, the EPG data 312 includes information related to the currently received programming and upcoming programming, e.g., programming information up to one week in advance. In some embodiments, some or all of the information included in the EPG data 312 is provided by the database 124 and/or the server 126.

Typically, a user will employ the EPG module 306 when the user wants to program the digital recorder 104 (and/or the computer system 118) to record an upcoming work or to see what is currently playing. The EPG module 306 provides the user with various menus such that the user can select to record based upon a selected day, time and channel, or based upon a selected program. If the user selects based upon a program, the EPG module 306 consults the EPG data 312 to determine the scheduling information (date, time, channel) of the program. The EPG module 306 provides the scheduling information to the EWG module 308.

Sometimes, the selected program is received at the digital recorder 104 and/or computer 118 in a digital transport stream. In that case, the EPG module 306 may provide the EWG module 308 with the appropriate packet identifiers for the packets that comprise the streams of the selected program. In the case of an MPEG transport stream, the EPG module 306 will use PATs and PMTs to determine the PIDs that comprise the selected program.

The EWG module 308 includes logic for receiving a work of content and logic for encoding the received work of content into a predetermined format. Typically, the EWG module 308 is adapted to convert an analog signal into the predetermined format and convert a digital work of content into the predetermined format. Protocols for the predetermined format include, but are not limited to, motion pictures expert group (MPEG), Advanced Visual Interface (AVI), Windows Media Video (WMV), Digital Versatile Disc (DVD), Versatile Compact Disc (VCD), and others known to those skilled in the art.

The EWG module 308 also includes logic for generating a supplemental information record and embedding the supplemental information record within an encoded work of content so as to generate an enhanced work of content. The EWG module 308 can read the EPG data 312 and extract information therefrom. The EWG module 308 can also receive information from the database 124 and/or the server 126. The EWG module 308 includes the logic for taking the information extracted from the EPG data and/or received from the database 124 and/or the server 126 and formatting the information into a predetermined format, e.g., a table or a record.

The EWM module 310 includes the logic for managing enhanced works of content that are stored on the storage device 210 and/or on other storage devices (not shown). Among other things, the EWM module 310 includes the logic for providing menus that enable the user to make selections and provide other input. The EWM module also includes the logic for playing back recorded works of content and using supplemental information records embedded in enhanced works of content. Typically, the EWM module 310 provides a user with the ability to search a library of enhanced works of content by searching through the supplemental information records.

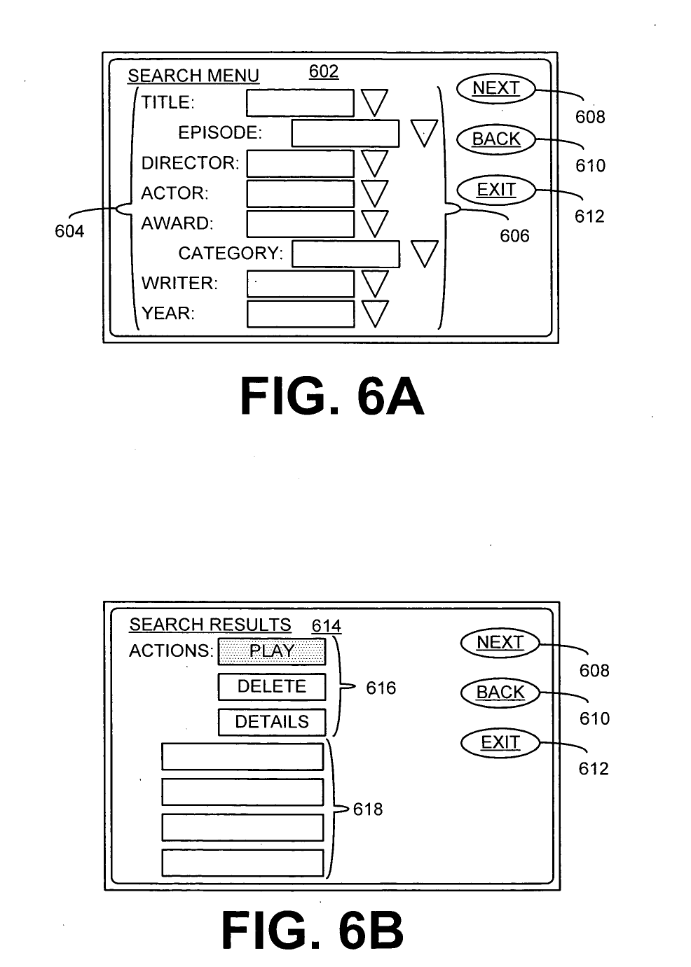

FIG. 4 illustrates the storage device 210 with enhanced works 402 and 404 stored therein. The enhanced work 402 includes “WORK 1” 406 and a supplemental information record 408. Similarly, the “enhanced work 2” 404 includes “WORK 2” 410 and a supplemental information record 412. The storage device 210 can be a hard drive, optical drive, tape drive or other device for storage electronic information. The supplemental information records 408 and 412 are embedded into the enhanced works 402 and 404, respectively. Because the supplemental information record 408 is part of the enhanced work 402, if the enhanced work 402 is copied, or deleted, the supplemental information record 408 is copied, or deleted with “WORK 1” 406.

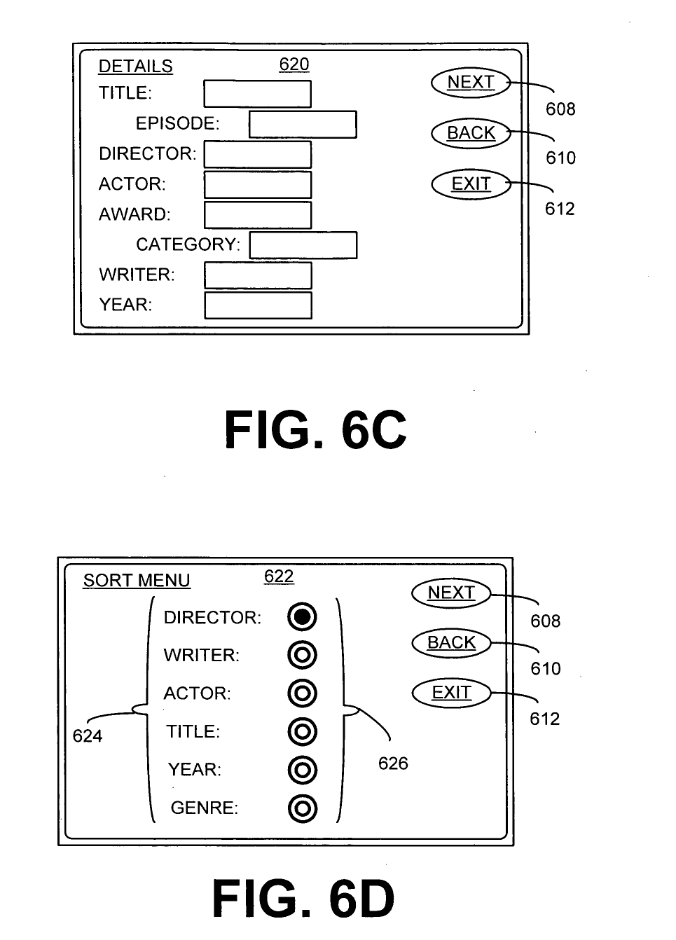

FIG. 5 illustrates further aspects of the exemplary supplemental information record 408. The supplemental information record 408 includes a plurality of fields including a title field 502, and an episode field 504. The title field 502 is populated with the title of “WORK 1” 406. In this example, “WORK 1” 406 is an episode of the television program “StarTrek,” and consequently, “StarTrek” is carried in the title field 502. Many works of content that are produced for television have both a program title and a episode title. Here, the episode field 504 is populated with “Balance of Terror”. For works of content that do not have an episode title, the episode field 504 is blank.

Also included in the plurality of fields of the supplemental information record is a year field 506. The year field 506 generally carries the year of copyright for the work, which in this example, is 1966. In some embodiments, the supplemental information record also includes a field for the date on which the enhanced work of content was recorded.

In the embodiment illustrated, the supplemental information record 408 also includes an actor field 508, a musician field 510, a director field 512, a genre field 514, a content rating field 516, a writer field 518, a critical review field 520, a user review/comments field 522, and a validity field 524.

In some embodiments, more, fewer and/or different fields can be included in the supplemental information record 408, and, in some embodiments, the fields are of variable length thereby enabling more than one entry per field. For example, the actor field 508 can include the names of several actors/actresses including guest actors/actresses. In other embodiments, the fields are of fixed length, but a category such as writer can have more than one field associated therewith so that multiple writers can be included.

The critical review field 520 carries a rating/review of the work. Typically, the rating/review for the work corresponds to information parsed from the EPG data 312, but the rating/review can also come from other sources such as the database 124 and/or the server 126.

The user review/comments field 522 carries information provided by the user. The user can provide his or her own rating system or provide any other information.

The validity field 524 carries information that can be used to determine whether the “WORK 1” 406 is valid, i.e., whether it has been corrupted. In some embodiments, the EWG 308 performs functions such as a check sum on the work of content as it is being recorded. A value corresponding to the function performed is then carried in the validity field 524. The EWM 310 includes logic for verifying that the “WORK 1” 406 is valid by performing the same function on the recorded “WORK 1” and comparing the resulting value with the value carried in the validity field 524.

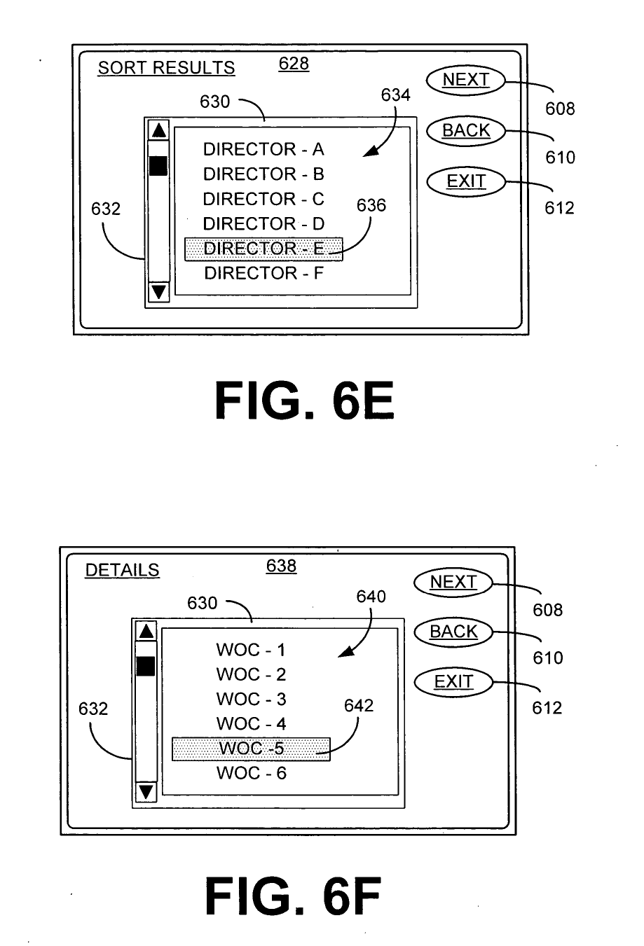

FIGS. 6A-6F illustrate exemplary menus provided by to a user by the multimedia processor 206. The menus provide a user friendly interface by which a user can communicate instructions to the EWM module 310 so as to, among other things, manage, sort, and search a library of enhanced works of content. In FIG. 6A, a “search menu” 602 is illustrated. The search menu 602 enables a user to search the storage device 210 for enhanced works of content using one or more search criteria. The “search menu” 602 includes a plurality of search criteria fields 604, and a plurality of pull-down tabs 606. The user can use the pull-down tabs 606 to populate the search criteria fields 604, or the user can populate the search criteria field 604 himself/herself using an input device. When the user clicks on one of the pull-down tabs 606, a list, which can include recent search criteria and/or recent results is displayed. The user selects one of the items listed, thereby populating the adjacent search criteria field 604.

The “search menu” 602 also includes a next button 608, a back button 610, and an exit button 612. The exit button 612 enables a user to “quit” interacting with the EWM module 310. The back button 610 enables the user to step back to the last displayed menu. The next button causes the multimedia processor 206 to search the supplemental information records of the enhanced works stored on the storage device 212 or on other storage devices (not shown) using the information contained in the search criteria field 604.

FIG. 6B illustrates an exemplary “search results” menu 614, which is displayed to the user. The “search results” menu 614 includes a plurality of “actions”, non-limiting examples of which include “play”, “delete”, and “details”, and results 618, which is a list of enhanced works that have supplemental information records that include a match of at least one of the search criteria used in the search menu 602. The user selects one of the actions 616, and the selected action is highlighted when displayed to the user. Similarly, the user can select one of the enhanced works listed in the results 618. If the action the user selects is “play”, then the work of content included in the highlighted (selected) enhanced work of content is displayed on a display device, e.g., computer screen/TV/etc. If the action the user selects is “delete”, the highlighted/selected enhanced work of content is deleted. If the action the user selects is “details”, at least a portion of the supplemental information record embedded in the selected enhanced work of content is displayed. The user selected action is implemented responsive to the user selecting the next button 608.

FIG. 6C illustrates an exemplary “details” page 620. The “details” page 620 is displayed to the user on a display device and provides the user with at least a portion of the content included in the supplemental information record of the selected enhanced work of content. Thus, the “detail” page 620 enables a user to view information included in the supplemental information record. In some embodiments, the search menu 602 and/or the search results 614 and/or the details page 620 include at least one scroll bar that the user employs to cause the content currently being displayed to shift so that currently unviewable content can be displayed. In one embodiment, information included in the details page 620 is hyperlinked to other information pages. Thus, if the user wants more information about any of the items listed in the details page, the user can select an item and retrieve further information by clicking on the selected item.

FIG. 6D illustrates an exemplary “sort menu” 622. The “sort menu” 622 includes a plurality of sort indicators 624, and a plurality of buttons 626. Each one of the sort indicators 624 is associated with one of the buttons 626. The user selects one of the sort indicators by clicking on the button associated with that button. For example, the button to the right of “DIRECTOR” is shaded indicating that the user has selected to sort enhanced works of content based upon the sort indicator of “director.” The sort indicators illustrated in FIG. 6D are non-limiting examples of parameters by which enhanced works of content can be sorted. In other embodiments, more, fewer, or different sort indicators could be used.

FIG. 6E illustrates an exemplary sort results page 628, which is provided to the user responsive to the user selecting a sort indicator and selecting the next button 608. The sort results page 628 includes a display window 630, which has a scroll bar 632. Inside of the display window 630 a list 634 of items is displayed. The list 634 includes items 636 and corresponds to the type of sort indicator chosen by the user. For example in FIG. 6E, the list 634 is a list of names of directors that are included in the enhanced works of content stored in the storage device 210. Typically, the names of the directors are listed in alphabetical (or reverse alphabetical) order.

Typically, an item 636 in list 634 is selected by a user positioning a cursor over the item to be selected and then “clicking” on the item 636. The selected item is then displayed as highlighted. The user can select one of the items in the list 634 to determine more information or details about the item. In the exemplary list 634 illustrated in FIG. 6E, the item 636, “DIRECTOR-E”, has been selected by the user and is shown as highlighted. The information presented to the user responsive to the user selecting an item and clicking on the next button 608 will include enhanced works of content stored on the storage device 210 in which “DIRECTOR-E” was the director. FIG. 6F illustrates an exemplary details page 638 having an exemplary list 640. The list 640 includes items (works of content) 642 in which “DIRECTOR-E” was the director. The exemplary iist 640 includes 6 items 642. Typically, the items 642 are listed alphabetically by title. The user can select one of the works of content for playing/viewing by selecting the item 642 and double clicking on the item. In another embodiment, information included in the details page 638 is hyperlinked to other information pages. Thus, if the user wants more information about any of the items listed in the details page, the user can select an item and retrieve further information by clicking on the selected item.

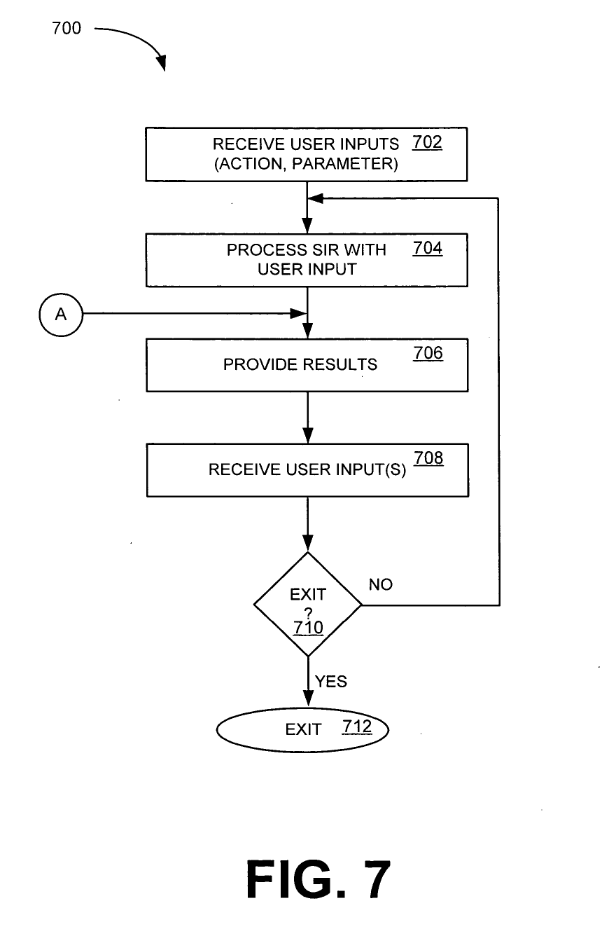

FIG. 7-9 are flow charts of steps that may be taken by the digital recorder 104 and/or the computer system 118. The flow charts illustrated in FIGS. 7-9 show the architecture, functionality, and operation of a possible implementation of the application specific software 304. In this regard, each block represents a module, segment, or portion of code, which comprises one or more executable instructions for implementing the specified logical function(s). It should also be noted that in some alternative implementations, the functions noted in the blocks may occur out of the order noted in FIGS. 7-9. For example, two blocks shown in succession in any of the FIGS. 7-9 may in fact be executed substantially concurrently or the blocks may sometimes be executed in the reverse order, depending upon the functionality involved, as will be further clarified hereinbelow.

FIG. 7 illustrates a flow chart 700 having exemplary steps that are taken by the multimedia processor 206. In step 702 the user provides one or more inputs. Typically, the user provides the inputs via a menu provided to the multimedia processor 206. The inputs frequently include user specified action and a parameter. For example, the user specified action could be “search” and the parameter could include at least one search criteria, or the user specified action could be “sort” and the parameter could be a sort indicator, or the user specified action could be “play” a selected enhanced work of content, etc.

In step 704, the multimedia processor 206 processes supplemental information records using the user inputs. Thus, if the user specified action had been “search” and the parameter included the search criteria of actor (John Doe), then the multimedia processor 206 would search all of the supplemental information records for works of content that have the actor “John Doe”. Similarly, if the user specified action had been “sort” and the parameter included the sort indicator of director, then the multimedia processor 206 would search all of the supplemental information records for their director's.

In step 706, the results of step 704 are provided to the user. The provided results correspond to the user specified action. For example, the provided results might be a list of enhanced works of content corresponding to a search or a list of the enhanced works of content stored in storage device 210 where the items in the list are sorted according to some user provided parameter or the provided results might be a details page, or the provided results might be the selected work of content, etc.

In step 708, user input is received. The user input might be, among other things, to perform a new search, play a selected enhanced work of content, display a details page for a selected enhanced work of content, etc.

In step 710, the multimedia processor 206 determines whether the user input corresponded to “exit”. If so, the user interface provided by the multimedia processor 206 executing the EWM module 310 is stopped. On the other hand, the process continues at step 704 if the user input was something other than exit.

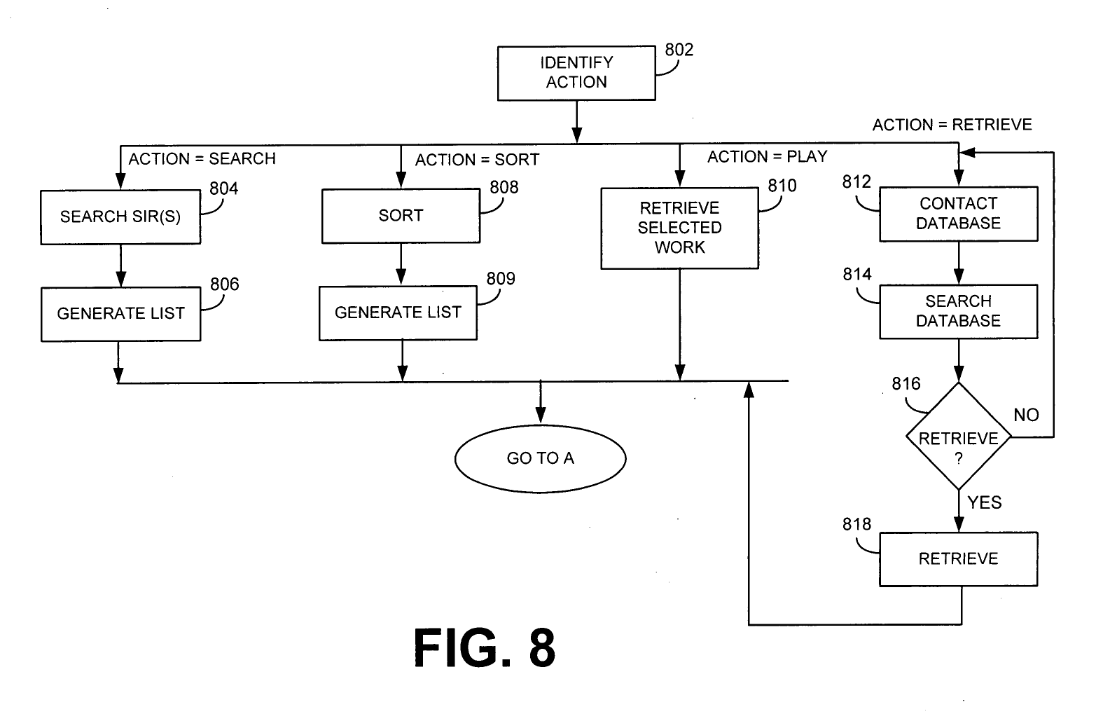

FIG. 8 illustrates exemplary steps that can be implemented in step 704. In step 802, the user specified action is identified. Non-limiting examples of user specified actions include, search, sort, play, delete, and retrieve.

If the action is search, the process continues at step 804. The multimedia processor 206 searches the supplemental information records for content that matches the user specified search criteria. In other words, the multimedia processor 206 essentially sorts the enhanced works of content into two groups: a group that is comprised of enhanced works of content that have supplemental information records matching the user specified search criteria and a second group comprised of all of the other enhanced works of content.

In step 806, the multimedia processor 206 generates a list of enhanced works of content that have supplemental information records that match at least one of the search criteria. In some embodiments, the user specifies search criteria that exclude enhanced works of content that match the search criteria. For example, if the user dislikes a certain performer, the user can have the search performed so as to exclude all enhanced works of content in which that performer performed.

It should be remembered that in some embodiments the user can sort both previous results and the entire library of enhanced works of content stored in the storage device 210. Thus, if the user specified action was sort, the process continues at step 808. In one case, the list generated in step 806 is sorted based upon some user provided parameter such as alphabetical by title, the date the work of content was created, the date the enhanced work of content was recorded, etc., and a new sorted list is generated in step 809. The sorted list is displayed to the user in step 706. In another case, instead of sorting the results of a search, the user can sort the library of enhanced works of content stored in storage device 210. In step 808, responsive to the user has specifying the action sort and a sort indicator, the multimedia processor 206 searches the supplemental information records for content that matches the user specified sort indicator. In step 809, the multimedia processor 206 generates a list that corresponds to the user specified sort indicator. For example, if a library of enhanced works of content is “sorted” by actor, then the list is a list of all of the actors that are included in the supplemental information records of library of enhanced works of content. Of course, the contents of the library are not actually “sorted”, rather, a catalog of the contents included in the library is “sorted” according to a parameter, sort indicator, provided by the user.

If the user specified action was play, then in step 810, at least a portion of the work of content that is embedded in the enhanced work of content selected by the user is retrieved from the storage device 212. The work of content is then played in step 706.

If the user specified action was retrieved, then in step 812, the multimedia processor 206 initiates contact with the database 124. In addition to specifying the action retrieved, the user specifies the work of content that is to be retrieved. In step 814, the multimedia processor 206 searches the database 124 for the work of content to be retrieved. In step 816, the multimedia processor determines whether the database 124 includes the work to be retrieved, and if so, the work is retrieved in step 818. If the database 124 does not include the work, then the process returns to step 812 contacts another source of works of content. In one embodiments, the digital recorder 104 and/or the computer system 118 are connected by a peer-to-peer application. In this embodiment, the digital recorder 104 can retrieve enhanced works of contents from the computer system 118 and the computer system 118 can retrieve enhanced works of content from the digital recorder 104. In this embodiment, the retrieved enhanced work of content is found on the host machine using the supplemental information record.

In some embodiments, the multimedia processor 206 does a validity check on an enhanced work of content before playing the selected work of content to the user. If the validity of the work of content is not confirmed, then the multimedia processor retrieves a valid work of content from a host machine such as the database 124 and/or the server 126 and/or devices in a peer-to-peer network.

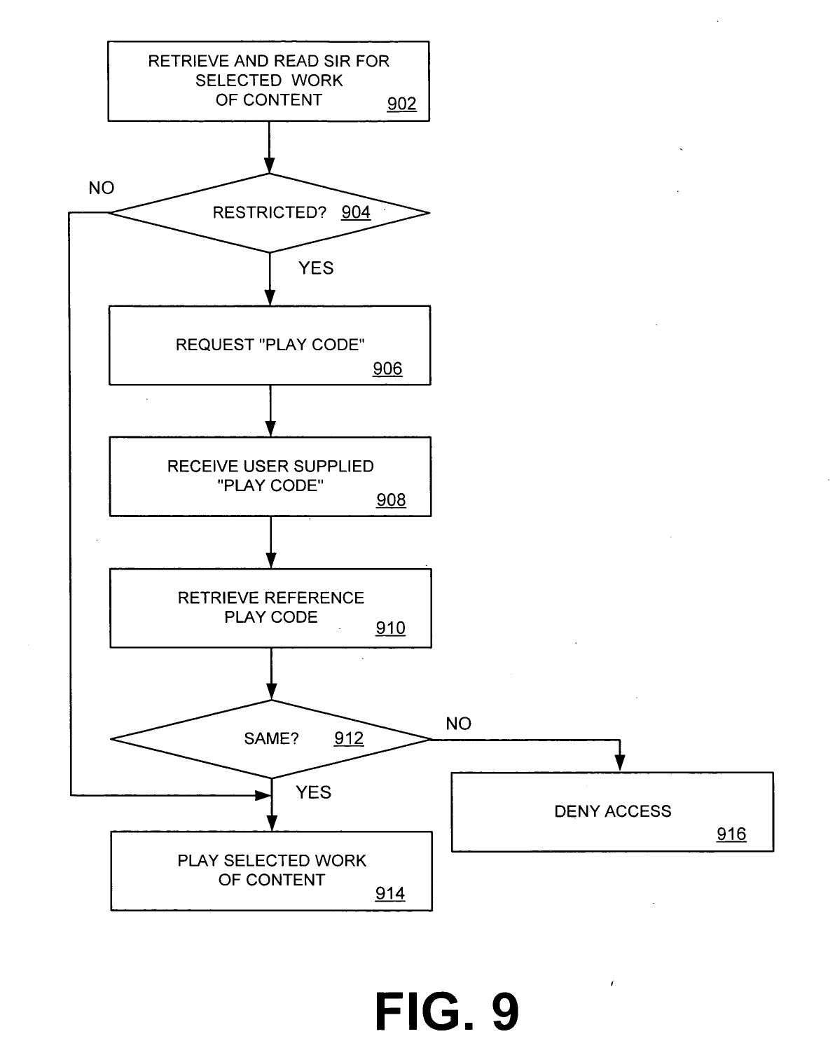

In one embodiment, the EWM module 310 includes logic for restricting access to recorded enhanced works using the supplemental information records embedded in the enhanced works of content. FIG. 9 illustrates exemplary steps that can be implemented to restrict access. In step 902, the supplemental information record of the user selected enhanced work of content is retrieved, and the content rating of the enhanced work of content is read from the supplemental information record. Typically, the content rating is a standard (industry) defined rating, e.g., G, PG, PG-13, etc. However, in some embodiments, the content rating is set by the user.

In step 904, a determination is made regarding whether the selected work of content is restricted. If the work of content is not restricted, then in step 914, the work of content is played. However, if the work of content is restricted, a request for a “play-code”, or “access code” is displayed to the user in step 906, and, in step 908 the user supplied “play-code” is received.

In step 910, a reference play-code is retrieved from the memory 216. The reference play-code is generally provided by an authority such as a parent who control access to the digital recorder 104 and/or the computer system 118.

In step 912, a comparison between the user supplied play-code and the parental supplied play-code is made. If the two play-codes are the same, then in step 914, the work of content is played. Otherwise, a message indicating that the user supplied play-code is invalid is displayed to the user and access to the selected work of content is denied.

In some embodiments, the memory 216 can include multiple reference play-codes, which enable different levels of access to restricted works of content. For example, a first play-code enables access to content that has the lowest level of restriction, e.g., PG-13, and a second play-code enables access to content that has the highest level of restriction, e.g., adult only. In this embodiment, the content rating of selected work of content is first determined, and then the correct reference code is retrieved from the memory 216 so that the correct comparison is made in step 912. Thus, the authority who establishes and provides play-codes to user can selectively grant access to recorded works of content according the content ratings of the works of content.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method of managing a library of enhanced works of content, which are defined as a compilation of a digital work of content and a supplemental information record that carries information related to the work of content, the method comprising the steps of:
accessing a supplemental information record of an enhanced work of content that is included in the library of enhanced works of content;
receiving a user input; and
processing the user input with at least a portion of the supplemental information record.

2. The method of claim 1, wherein the supplemental information record of each enhanced work of content is embedded in the enhanced work of content.

3. The method of claim 1, wherein the supplemental information record included in a given enhanced work of content carries program information for a given work of content included in the given enhanced work of content.

4. The method of claim 3, wherein the program information includes at least one of the following: a title for the given work; an episode name for the given work of content; a name for a performer associated with the given work of content; a name of a director for the given work of content; a name of a publisher for the given work of content; a program channel identifier for the given work of content; a category for the given work of content; a genre for the given work of content; and a rating for the given work of content.

5. The method of claim 1, wherein the library of enhanced works of content includes a plurality of enhanced works of content and the step of processing further includes the steps of:
sorting the multiple enhanced works of content into a first group and a second group based at least upon the user input and the supplemental information records of the enhanced works of content; and
providing a list of the enhanced works of content that are included in the first group.

6. The method of claim 5, wherein the supplemental information records of the enhanced works of content of the first group include an item that matches a search criteria provided by the user.

7. The method of claim 5, wherein the supplemental information records of the enhanced works of content of the first group exclude an item that matches a search criteria provided by the user.

8. The method of claim 1, wherein the step of processing further includes the step of:
searching the supplemental information records of the enhanced works of content included in the library to determine which of the enhanced works of content include information that matches a search criteria, wherein the search criteria is included in the user input; and
providing a list of works of content, wherein the works of content that are included in the list have supplemental information records that include information that matches the search criteria.

9. The method of claim 1, wherein the step of processing further includes the step of:
restricting access to a specific work of content included in a specific enhanced work of content that is included in the library of enhanced works of content.

10. The method of claim 9, wherein the step of restricting access further includes the steps of:
using at least a portion of supplemental information record of the specific enhanced work of content to determine a content rating for the specific work of content; and
determining whether the specific work of content is restricted based upon the content rating.

11. The method of claim 10, wherein the step of restricting access further includes the steps of:
responsive to determining that the specific work of content is not restricted, further including the step of;
granting access to the specific work of content; and
responsive to determining that the specific work of content is restricted, further including the steps of:
requesting a play-code for the specific work of content;
receiving a user supplied play-code;
determining whether to grant access to the specific work of content based at least in part on the user supplied play-code; and
responsive to determining to grant access, granting access to the specific work of content.

12. An apparatus for managing a library of enhanced works of content, which are defined as a compilation of a digital work of content and a supplemental information record that carries information related to the work of content, the apparatus comprising:
a memory having an enhanced work management module therein; and
a processor in communication with the memory, the processor adapted to implement the enhanced work management module to access a given supplemental information record of an enhanced work of content that is included in a library of enhanced works of content and adapted to receive a user input and to process the user input with at least a portion of the given supplemental information record.

13. The apparatus of claim 12, wherein the given supplemental information record of each enhanced work of content is embedded in the enhanced work of content.

14. The apparatus of claim 12, wherein the given supplemental information record is included in a given enhanced work of content carries program information for a given work of content that is included in the given enhanced work of content.

15. The apparatus of claim 14, wherein the program information includes at least one of the following: a title for the given work of content; an episode name for the given work of content; a name for a performer associated with the given work of content; a name of a director for the given work of content; a name of a publisher for the given work of content; a program channel identifier for the given work of content; a category for the given work of content; a genre for the given work of content; and a rating for the given work of content.

16. The apparatus of claim 12, wherein the enhanced work management module is further adapted to sort the multiple enhanced works of content into a first group and a second group based at least upon the user input and the supplemental information records of the enhanced works of content, and adapted to provide a list of the enhanced works of content that are included in the first group.

17. The apparatus of claim 16, wherein the supplemental information records of the enhanced works of content of the first group include an item that matches a search criteria provided by the user.

18. The apparatus of claim 16, wherein the supplemental information records of the enhanced works of content of the first group exclude an item that matches a search criteria provided by the user.

19. The apparatus of claim 12, wherein the enhanced work management module is further adapted to search the supplemental information records of the enhanced works of content included in the library to determine which of the enhanced works of content include information that matches a search criteria, wherein the search criteria is included in the user input, and adapted to provide a list of works of content, wherein the works of content that are included in the list have supplemental information records that include information that matches the search criteria.

20. The apparatus of claim 12, wherein the enhanced work management module is further adapted to restrict access to a particular work of content included in a particular enhanced work of content that is included in the library of enhanced works of content.

21. The apparatus of claim 20, wherein the enhanced work management module is further adapted to use at least a portion of supplemental information record of the particular enhanced work of content to determine a content rating for the particular work of content and further adapted to determine whether the particular work of content is restricted based upon the content rating.

22. The apparatus of claim 21, wherein the enhanced work management module is further adapted to grant access to the particular work of content responsive to determining that the particular work of content is not restricted and further adapted to:
request a play-code for the particular work of content responsive to determining that the particular work of content is restricted;
receive a user supplied play-code;
determine whether to grant access to the particular work of content based at least in part on the user supplied play-code; and
grant access to the particular work of content responsive to determining to grant access to the particular work of content.

23. A program embodied in a computer readable medium, the program comprising:
logic configured to access a supplemental information record of an enhanced work of content that is included in a library of enhanced works of content, wherein an enhanced work of content is defined as a compilation of a digital work of content and a supplemental information record that carries information related to the work of content
logic configured to receive a user input; and
logic configured to process the user input with at least a portion of the supplemental information record.

24. The program of claim 23, wherein the supplemental information record of each enhanced work of content is embedded in the enhanced work of content.

25. The program of claim 23, wherein the supplemental information record included in a given enhanced work of content carries program information for a given work of content included in the given enhanced work of content.

26. The program of claim 25, wherein the program information includes at least one of the following: a title for the given work of content; an episode name for the given work of content; a name for a performer associated with the given work of content; a name of a publisher for the given work of content; a program channel identifier for the given work of content; a category for the given work of content; a genre for the given work of content; a name of a director for the given work of content; and a rating for the given work of content.

27. The program of claim 23, wherein the library of enhanced works of content includes a plurality of enhanced works of content, and further including:
logic configured to sort the multiple enhanced works of content into a first group and a second group based at least upon the user input and the supplemental information records of the enhanced works of content; and
logic configured to provide a list of the enhanced works of content that are included in the first group.

28. The program of claim 27, wherein the supplemental information records of the enhanced works of content of the first group include an item that matches a search criteria provided by the user.

29. The program of claim 27, wherein the supplemental information records of the enhanced works of content of the first group exclude an item that matches a search criteria provided by the user.

30. The program of claim 23, further including:
logic adapted to search the supplemental information records of the enhanced works of content included in the library to determine which of the enhanced works of content include information that matches a search criteria, wherein the search criteria is included in the user input; and
logic configured to provide a list of works of content, wherein the works of content that are included in the list have supplemental information records that include information that matches the search criteria.

31. The program of claim 23, further including:
logic configured to restrict access to a specific work of content included in a specific enhanced work of content that is included in the library of enhanced works of content.

32. The program of claim 31, further including:
logic configured to use at least a portion of supplemental information record of the specific enhanced work of content to determine a content rating for the specific work of content; and
logic configured to determine whether the specific work of content is restricted based upon the content rating.

33. The program of claim 32, further including:
logic configured to grant access to the specific work of content responsive to determining that the specific work of content is not restricted;
logic configured to request a play-code for the specific work of content responsive to determining that the specific work of content is restricted;
logic configured to receive a user supplied play-code;
logic configured to determine whether to grant access to the specific work of content based at least in part on the user supplied play-code;
logic configured to grant access to the specific work of content responsive to determining to grant access to the specific work of content; and
logic configured to deny access to the specific work of content responsive to determining not to grant access to the specific work of content.

34. An apparatus for managing a library of enhanced works of content, the apparatus comprising:
a storage device having a library of enhanced works of content stored therein, wherein a given enhanced work of content is defined as a compilation of a given digital work of content and a given supplemental information record that carries program information related to the given work of content, wherein the program information includes at least one of the following: a title for the given work of content; a name of a publisher for the given work of content; a program channel identifier for the given work of content; a category for the given work of content; a genre for the given work of content; an episode name for the given work of content; a name for a performer associated with the given work of content; a name of a director for the given work of content; and a rating for the given work of content;
a memory having an enhanced work management module therein; and
a processor in communication with the memory, the processor adapted to receive a user input and adapted to implement the enhanced work management module to search the supplemental information records included in the library of enhanced works of content and provide a list of works of content corresponding to a search criteria.

35. The apparatus of claim 34, wherein the works of content included in the list of works of content have supplemental information records associated therewith that include an item that matches the search criteria.

36. The apparatus of claim 34, wherein the works of content included in the list of works of content have supplemental information records associated therewith that do not include an item that matches the search criteria.

37. A method managing a library of enhanced works of content, the method comprising the steps of:
accessing a library of enhanced works of content, wherein a given enhanced work of content is defined as a compilation of a digital given work of content and a given supplemental information record that carries program information related to the given work of content, wherein the program information includes at least one of the following: a title for the given work of content; an episode name for the given work of content; a name for a performer associated with the given work of content; a name of a director for the given work of content; a name of a publisher for the given work of content; a program channel identifier for the given work of content; a category for the given work of content; a genre for the given work of content; and a rating for the given work of content;
receiving a user input for a search criteria; and
searching the supplemental information records included in the library of enhanced works of content and provide a list of works of content corresponding to the search criteria.

38. The method of claim 37, wherein the works of content included in the list of works of content have supplemental information records associated therewith that include an item that matches the search criteria.

39. The method of claim 37, wherein the works of content included in the list of works of content have supplemental information records associated therewith that do not include an item that matches the search criteria.
